(19) United States
(12) Patent Application Publication
(10) Pub. No.: US 2026/0082186 A1
(43) Pub. Date: Mar. 19, 2026

(54) SENSOR SYSTEM, TRANSMISSION TERMINAL AND TRANSMISSION METHOD

(71) Applicant: Kabushiki Kaisha Toshiba, Kawasaki-shi (JP)

(72) Inventors: Yuki UEDA, Yokohama (JP); Takashi USUI, Saitama (JP)

(73) Assignee: Kabushiki Kaisha Toshiba, Kawasaki-shi (JP)

(21) Appl. No.: 19/307,122

(22) Filed: Aug. 22, 2025

(30) Foreign Application Priority Data
Sep. 17, 2024 (JP) 2024-159855

(51) Int. Cl. H04W 4/38; H04L 67/12

(52) U.S. Cl. CPC H04W 4/38; H04L 67/12

(57) ABSTRACT

According to one embodiment, a sensor system, a transmission terminal, and a transmission method that can curb a decrease in time estimation accuracy are provided. The sensor system includes one more sensors, one or more transmission terminals, and a collection apparatus. The one or more transmission terminals include a first communicator and a second communicator. The first communicator transmits first transmission data including time information to be used for time estimation to the collection apparatus in a wireless manner. The second communicator transmits second transmission data including information acquired on the basis of the physical quantity sensed by the one or more sensors to the collection apparatus at a frequency different from a frequency used by the first communicator in a wireless manner. The collection apparatus includes a reception time determiner and a time information processor. The reception time determiner determines a plurality of reception times of a plurality of pieces of first transmission data transmitted from the first communicator. The time information processor performs the time estimation on the basis of the plurality of pieces of first transmission data and the plurality of reception times.

### CROSS-REFERENCE TO RELATED APPLICATION

This application is based upon and claims the benefit of priority from Japanese Patent Application No. 2024-159855, filed September/17/2024, the entire contents of which are incorporated herein by reference.

### FIELD

Embodiments described herein relate generally to a sensor system, a transmission terminal and a transmission method.

### BACKGROUND

Recently, collection of various types of sensing data has become possible through power saving, decrease in price of sensors, or the development of networks. Accordingly, trials to utilize sensing data have become active. Structural health monitoring is known as a method of utilizing sensing data. Structural health monitoring is a technique of sensing physical quantities such as displacement, vibration, and pressures using sensors installed in a structure such as a bridge and diagnosing damage or deterioration of the structure using various signal processing methods.

In the related art, sensors are connected in a wired manner and sensing data is measured, but wired connection is troublesome in installation or management and flexibility or extendability is limited. Therefore, a method of wirelessly transmitting sensing data acquired from sensors from a transmission terminal has been studied. In a system including a plurality of terminal devices using a wireless network, there are a plurality of clocks, and thus time synchronization is necessary. Therefore, in the related art, a time estimation method described in Patent Document 1 has been proposed.

In the technique described in Patent Document 1, a collection apparatus side performs time estimation on the basis of transmission times included in a plurality of pieces of transmission data transmitted from transmission terminals and reception times of the plurality of pieces of transmission data. Accordingly, the problem with time synchronization can be solved. When sensing data is transmitted in a wireless manner, compression of data is performed due to limitation on a communication band. For example, data is compressed by transmitting only a feature quantity acquired from the sensing data.

In this way, in wireless transmission of AE data in the structure health monitoring according to the related art, data converted to a feature quantity is generally transmitted. However, when detailed analysis is performed, waveform data is also necessary in addition to the feature quantity. The waveform data has a larger amount of data than the feature quantity, and thus it is difficult to transmit a large amount of data when the number sensors or the number of AE hits is large. In the time estimation method according to the related art, since transmission times and reception times need to be correlated, the time estimation method is not suitable for transmission of waveform data of which a transmission time period is long, and time estimation accuracy may be lowered.

### BRIEF DESCRIPTION OF THE DRAWINGS

FIG. 1 is a diagram illustrating a system configuration of a sensor system according to a first embodiment.

FIG. 2 is a block diagram schematically illustrating functions of a transmission terminal according to the first embodiment.

FIG. 3 is a block diagram schematically illustrating an internal configuration of a signal processor according to the first embodiment.

FIG. 4 is a block diagram schematically illustrating functions of a collection apparatus according to the first embodiment.

FIG. 5 is a diagram illustrating time processing according to the first embodiment.

FIG. 6 is a diagram illustrating time processing according to the first embodiment.

FIG. 7 is a sequence diagram illustrating a process flow that is performed by the sensor system according to the first embodiment.

FIG. 8 is a diagram illustrating a system configuration of a sensor system according to a second embodiment.

FIG. 9 is a block diagram schematically illustrating functions of a collection apparatus according to the second embodiment.

FIG. 10 is a sequence diagram illustrating a process flow that is performed by the sensor system according to the second embodiment.

### DETAILED DESCRIPTION

The present invention provides a sensor system, a transmission terminal, and a transmission method that can curb a decrease in time estimation accuracy.

According to one embodiment, a sensor system according to an embodiment includes one or more sensors, one or more transmission terminals, and a collection apparatus. The one or more sensors sense a physical quantity. The one or more transmission terminals are connected to the one or more sensors. The collection apparatus collects information transmitted from the one or more transmission terminals. The one or more transmission terminals include a first communicator and a second communicator. The first communicator transmits first transmission data including time information to be used for time estimation to the collection apparatus in a wireless manner. The second communicator transmits second transmission data including information acquired on the basis of the physical quantity sensed by the one or more sensors to the collection apparatus at a frequency different from a frequency used by the first communicator in a wireless manner. The collection apparatus includes a reception time determiner and a time information processor. The reception time determiner determines a plurality of reception times of a plurality of pieces of first transmission data transmitted from the first communicator. The time information processor performs the time estimation on the basis of the plurality of pieces of first transmission data and the plurality of reception times.

Hereinafter, a sensor system, a transmission terminal, and a transmission method according to an embodiment will be described with reference to the accompanying drawings.

### First embodiment

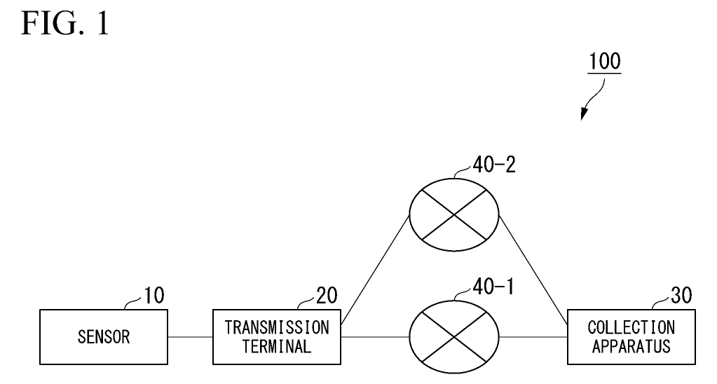

FIG. 1 is a diagram illustrating a system configuration of a sensor system 100 according to a first embodiment. The sensor system 100 includes a sensor 10, a transmission terminal 20, and a collection apparatus 30. The sensor 10 and the transmission terminal 20 are connected in a wired manner. The transmission terminal 20 and the collection apparatus 30 are wirelessly connected via networks 40-1 and 40-2. The network 40-1 and the network 40-2 are networks of different wireless standards. The network 40-1 is, for example, a network of an industrial, scientific and medical (ISM) band in which frequencies in a 920 MHz band are available. The network 40-2 is, for example, a network in which frequencies in a 2.4 GHz band, a 5 GHz band, or the like are available. In FIG. 1, a configuration in which the sensor system 100 includes one sensor 10 and one transmission terminal 20 is illustrated, but the sensor system 100 may include a plurality of sensors 10 and a plurality of transmission terminals 20.

The sensor 10 is a sensor that senses a physical quantity. The sensor 10 may include, for example, an acoustic emission (AE) sensor, an accelerator sensor, a microphone, and a temperature sensor. The sensor 10 may be another sensor as long as it can sense a physical quantity. The sensor 10 converts the sensed physical quantity to an electrical signal. The sensor 10 transmits the electrical signal to the transmission terminal 20.

In the following description, it is assumed that the sensor 10 is a sensor that detects elastic waves generated from the inside of a structure, and the same processes are performed even when the sensor 10 is another sensor. The sensor 10 is installed in a structure. The sensor 10 is installed at a position at which elastic waves can be detected. For example, the sensor 10 is installed on one of a top surface, a side surface, and a bottom surface of a structure. The sensor 10 converts detected elastic waves to an electrical signal which is a voltage signal. For example, a piezoelectric element having sensitivity in a range of 10 kHz to 1 MHz is used for the sensor 10. The sensor 10 may be a piezoresistance type using a piezoresistance effect, a capacitance type using a change in capacitance, or a piezoelectric type using a piezoelectric effect, and the type of the sensor 10 may be any type thereof.

In the following description, a bridge formed of concrete is described as an example of a structure, but the structure is not limited to a bridge. The structure is not particularly limited as long as it is a structure in which elastic waves are generated with generation and propagation of a crack or an external impact (for example, rain or artificial rain). For example, the structure may be a bedrock. The bridge is not limited to a structure constructed over a river, a valley, or the like and includes various structures (for example, a viaduct over an expressway) provided over the ground.

The transmission terminal 20 includes a plurality of wireless communicators and performs wireless communication with the collection apparatus 30. The plurality of wireless communicators include, for example, a first communicator and a second communicator. The first communicator transmits first transmission data including at least time information used for time estimation in the collection apparatus 30 to the collection apparatus 30. The first communicator may transmit a feature quantity based on elastic waves detected by the sensor 10 to the collection apparatus 30. The second communicator transmits second transmission data including predetermined data to the collection apparatus 30. The predetermined data is, for example, waveform data of the elastic waves detected by the sensor 10.

A communication speed of the second communicator is equal to or higher than a communication speed of the first communicator. The first communicator and the second communicator may use different frequencies in the same wireless standard or may use different wireless standards. In the following description, it is assumed that the first communicator performs wireless communication using a 920 MHz band and the second communicator performs wireless communication using Wi-Fi (registered trademark). This is an example, and any wireless standard may be used as long as the communication speed of the second communicator is equal to or higher than the communication speed of the first communicator.

For example, the transmission terminal 20 senses an event on the basis of an electrical signal output from the sensor 10 and transmits the first transmission data including at least one of an occurrence time of the sensed event (hereinafter referred to as an “event sensing time”) and a transmission time to the collection apparatus 30 via the first communicator. Here, the event is an event which occurs outside or inside of the device. In the following embodiment, it is assumed that the event is an event (for example, sensing of elastic waves) which occurs outside of the device. The transmission time is a time at which the transmission terminal 20 transmits the first transmission data to the collection apparatus 30.

The transmission terminal 20 adds an event sensing time, a transmission time, or specific identification information to the second transmission data and transmits the second transmission data to the collection apparatus 30 via the second communicator. The event sensing time, the transmission time, or the specific identification information is used to correlate the first transmission data and the second transmission data which are transmitted on the basis of elastic waves generated in the same event. As described above, in the transmission terminal 20, the first transmission data and the second transmission data are transmitted by different communicators. Accordingly, the collection apparatus 30 needs to correlate the first transmission data and the second transmission data based on the elastic waves generated in the same event. For this purpose, the event sensing time, the transmission time, or the specific identification information is used. When the specific identification information is included in the second transmission data, the specific identification information needs to be included in the first transmission data.

The collection apparatus 30 collects the first transmission data and the second transmission data transmitted from the transmission terminal 20. The collection apparatus 30 collects a plurality of transmission times and a plurality of event sensing times from one transmission terminal 20 for each sensor 10. The collection apparatus 30 performs processes based on the plurality of transmission times, the plurality of event sensing times, and reception times corresponding to the transmission times which are collected. A reception time corresponding to a transmission time is a time at which the first transmission data including information of the transmission time transmitted from the transmission terminal 20 is received.

The collection apparatus 30 correlates the first transmission data and the second transmission data received at different timings. Specifically, the collection apparatus 30 correlates the first transmission data and the second transmission data on the basis of one of the event sensing time, the transmission time, and the specific identification information included in the first transmission data and one of the event sensing time, the transmission time, and the specific identification information included in the second transmission data.

### Configuration of transmission terminal 20

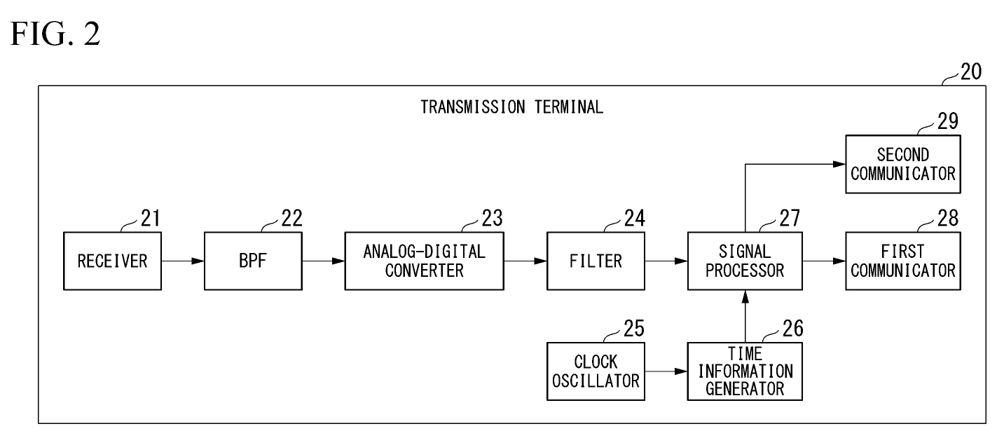

FIG. 2 is a block diagram schematically illustrating functions of the transmission terminal 20 according to the first embodiment. The transmission terminal 20 includes a receiver 21, a BPF 22, an analog-digital converter 23, a filter 24, a clock oscillator 25, a time information generator 26, a signal processor 27, a first communicator 28, and a second communicator 29.

The receiver 21 receives an electrical signal output from the sensor 10. Accordingly, the receiver 21 acquires elastic waves detected by the sensor 10. The receiver 21 outputs the received electrical signal to the BPF 22.

The BPF 22 reduces noise from the electrical signal received by the receiver 21. The BPF 22 is a band-pass filter for reducing noise. The BPF 22 outputs the noise-reduced signal to the analog-digital converter 23.

The analog-digital converter 23 converts the noise-reduced signal from an analog signal to a digital signal by quantizing the noise-reduced signal output from the BPF 22. The analog-digital converter 23 outputs the digital signal to the filter 24.

The filter 24 reduces noise from the digital signal output from the analog-digital converter 23. The filter 24 is a digital filter for reducing noise. The filter 24 outputs the noise-reduced digital signal to the signal processor 27.

In the following description, processing that is performed by the receiver 21, the BPF 22, the analog-digital converter 23, and the filter 24 is referred to as pre-processing.

The clock oscillator 25 generates a clock signal. Specifically, the clock oscillator 25 determines a time width of 1 second in the transmission terminal 20. The clock oscillator 25 is constituted, for example, using a voltage-varying quartz oscillator such as voltage-controlled crystal oscillator (VCXO). The clock oscillator 25 outputs the clock signal to the time information generator 26.

The time information generator 26 determines a time in the transmission terminal 20 according to the clock signal output from the clock oscillator 25. The time information generator 26 is, for example, a counter including a register. That is, the time information generator 26 counts an edge of the clock signal and stores a cumulative count value from powering-on of the transmission terminal 20 as time information in the register.

The signal processor 27 determines the event sensing time and the transmission time on the basis of the noise-reduced digital signal output from the filter 24 and the time information generated by the time information generator 26. The event sensing time may be, for example, a clock number or the time of the day.

The signal processor 27 is configured by a digital circuit. The digital circuit is realized, for example, by a field-programmable gate array (FPGA) or a microcomputer. The digital circuit may be realized by a dedicated large-scale integration (LSI) circuit. The signal processor 27 may include a nonvolatile memory such as a flash memory or a removable memory.

The first communicator 28 is a communication interface that communicates with the collection apparatus 30 via the network 40-1. The first communicator 28 transmits first transmission data including at least one of the event sensing time and the transmission time determined by the signal processor 27 to the collection apparatus 30 through wireless communication at a first timing. The first transmission data may include a feature quantity of elastic waves. The first timing may be, for example, a timing at which a predetermined time period determined by the signal processor 27 has elapsed or a timing at which a predetermined time period has elapsed after transmission has been performed once.

A wireless frequency band used for communication of the first communicator 28 is, for example, a 920 MHz band. The first communicator 28 can also transmit the event sensing time and the transmission time at an appropriate timing such as transmitting the event sensing time and the transmission time in synchronization with each other or transmitting the event sensing time and the transmission time separately.

The second communicator 29 is a communication interface that communicates with the collection apparatus 30 via the network 40-2. The second communicator 29 transmits second transmission data including predetermined data output from the signal processor 27 to the collection apparatus 30 through wireless communication at a second timing. The predetermined data may be, for example, waveform information of elastic waves. The second timing may be, for example, a timing at which the time determined by the signal processor 27 has come or a timing at which transmission of predetermined data has been required from the collection apparatus 30.

A wireless frequency band used for communication of the second communicator 29 is, for example, a 2.4 GHz or5 GHz band. As described above, the communication speed of the second communicator 29 is equal to or higher than the communication speed of the first communicator 28. When the first communicator 28 and the second communicator 29 use different frequencies in the same wireless standard, the first communicator 28 and the second communicator 29 can perform wireless communication with the collection apparatus 30 via the same network 40-1.

### Configuration of signal processor 27

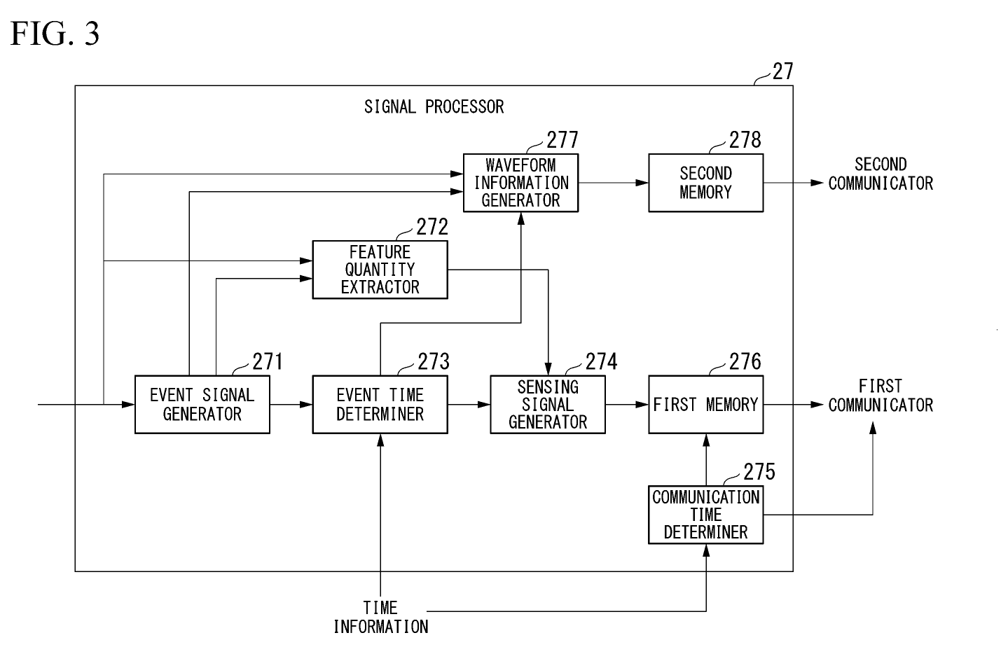

FIG. 3 is a block diagram schematically illustrating an internal configuration of the signal processor 27 according to the first embodiment. The signal processor 27 includes an event signal generator 271, a feature quantity extractor 272, an event time determiner 273, a sensing signal generator 274, a communication time determiner 275, a first memory 276, a waveform information generator 277, and a second memory 278.

The event signal generator 271 generates a gate signal indicating whether a waveform of the input noise-reduced digital signal continues. The event signal generator 271 is realized, for example, by an envelope detector and a comparator. The envelope detector detects an envelope of the noise-reduced digital signal. The envelope is extracted, for example, by squaring the noise-reduced digital signal and performing a predetermined process (for example, a process using a low-pass filter or a Hilbert transformation) on the squared output value. The comparator determines whether the envelope of the noise-reduced digital signal is equal to or greater than a predetermined threshold value.

When the envelope of the noise-reduced digital signal is equal to or greater than a first threshold value, the event signal generator 271 outputs a first gate signal indicating that the waveform of the noise-reduced digital signal continues to the feature quantity extractor 272, the event time determiner 273, and the waveform information generator 277. When the first gate signal is output, it means that an event has occurred. On the other hand, when the envelope of the noise-reduced digital signal is less than the first threshold value, the event signal generator 271 outputs a second gate signal indicating that the waveform of the noise-reduced digital signal does not continue to the feature quantity extractor 272, the event time determiner 273, and the waveform information generator 277. When the second gate signal is output, it means that an event has ended. That is, it means that elastic waves are generated in a period in which the second gate signal is output after the first gate signal has been output from the event signal generator 271.

ChangeFinder, Akaike’s information criterion (AIC), or the like may be used as a method of detecting occurrence of an event. In this configuration, the event signal generator 271 determines whether the waveform of the noise-reduced signal continues on the basis of an envelope, but the event signal generator 271 may perform a process on the noise-reduced signal or a signal obtained by applying an absolute value thereto.

The feature quantity extractor 272 receives the noise-reduced digital signal output from the filter 24 and the gate signal output from the event signal generator 271 as inputs. The feature quantity extractor 272 extracts a feature quantity of the noise-reduced digital signal using the noise-reduced digital signal input while the first gate signal is being input. The feature quantity extractor 272 does not perform any process while the second gate signal is being input. The feature quantity is information indicating a feature of the noise-reduced digital signal. That is, the feature quantity of the noise-reduced digital signal is a feature quantity of elastic waves detected by the sensor 10.

Examples of the feature quantity include the amplitude [mV] of a waveform, a rising time [μsec] of a waveform, a duration time [μsec] of a gate signal, a zero-cross count value (times), the energy [arb.] of a waveform, a frequency [Hz], and a root mean square (RMS) value. The feature quantity extractor 272 outputs the extracted feature quantity to the sensing signal generator 274. The feature quantity extractor 272 correlates a sensor ID with a parameter associated with the feature quantity at the time of outputting the parameter associated with the feature quantity. The sensor ID indicates identification information for identifying the sensor 10.

The amplitude of a waveform is, for example, a value of the maximum amplitude of the noise-reduced digital signal. The rising time of a waveform is, for example, a time T1 from the rising start of a gate signal to a time point at which the noise-reduced digital signal reaches the maximum value. The duration time of a gate signal is, for example, a time from the rising start of the gate signal to a time point at which the amplitude becomes less than a preset value. The zero-cross count value is, for example, the number of times the noise-reduced digital signal crosses a reference line passing through a zero value.

The energy of a waveform is, for example, a value obtained by temporally integrating a value obtained by squaring the amplitude of the noise-reduced digital signal at each time point. Definition of energy is not limited to the aforementioned description and may be, for example, an approximation using an envelope of a waveform. The frequency is a frequency of the noise-reduced digital signal. The RMS value is, for example, a value obtained by squaring the amplitude of the noise-reduced digital signal at each time point and calculating a square root thereto.

The event time determiner 273 receives one gate signal of the first gate signal and the second gate signal output from the event signal generator 271 and the time information output from the time information generator 26 as inputs. The event time determiner 273 determines an event sensing time on the basis of the input gate signal. Specifically, the event time determiner 273 determines a time at which the envelope becomes equal to or greater than the first threshold value, that is, a time at which the first gate signal is input, as the event sensing time. The event time determiner 273 outputs time information indicating the determined event sensing time to the sensing signal generator 274. When the event sensing time is used for correlation with the second transmission data transmitted from the second communicator 29, the event time determiner 273 may output the time information indicating the determined event sensing time to the waveform information generator 277. The event time determiner 273 does not perform a process while the second gate signal is being input.

The sensing signal generator 274 generates sensing information in which the feature quantity output from the feature quantity extractor 272 is correlated with the time information indicating the event sensing time output from the event time determiner 273. The sensing signal generator 274 outputs the generated sensing information to the first memory 276.

The communication time determiner 275 receives the time information output from the time information generator 26 as an input. The communication time determiner 275 monitors the first communicator 28 and determines the transmission time. The communication time determiner 275 may cause the first communicator 28 to perform wireless communication at the notified time by determining the transmission time and notifying the first communicator 28 of the transmission time before transmitting the first transmission data. The transmission time generally indicates a start time, but is not limited thereto as long as it is single. For example, the first communicator 28 may output a signal to the outside at the time of start of transmission, and the communication time determiner 275 may determine the transmission time using that signal. The communication time determiner 275 may determine the transmission time during wireless transmission and add the transmission time to transmission data to be transmitted by the first communicator 28 or may transmit the transmission time after wireless transmission has ended.

The communication time determiner 275 may correlate information indicating the determined transmission time with the sensing information stored in the first memory 276. When the transmission time is used for correlation with the second transmission data which is transmitted by the second communicator 29, the communication time determiner 275 may output time information indicating the determined transmission time to the waveform information generator 277.

The first memory 276 includes, for example, a dual-port RAM and stores at least sensing information output from the sensing signal generator 274. When information indicating the transmission time is acquired from the communication time determiner 275, the first memory 276 correlates the transmission time with the sensing information and stores the resultant information.

The waveform information generator 277 receives the noise-reduced digital signal output from the filter 24 and the gate signal output from the event signal generator 271 as inputs. The waveform information generator 277 generates the noise-reduced digital signal input from the timing at which the first gate signal is input to the timing at which the second gate signal is input as waveform information. In this way, the waveform information generator 277 determines data (for example, waveform information) to be transmitted by the second communicator 29 on the basis of a signal intensity of the noise-reduced digital signal (for example, a signal intensity of elastic waves). The waveform information generator 277 stores the generated waveform information in the second memory 278. When the waveform information is stored in the second memory 278, the waveform information generator 277 adds the event sensing time, the transmission time, or the specific identification information as a header or a footer.

The waveform information generator 277 may generate the noise-reduced digital signal input before the first gate signal is input as the waveform information using a memory such as a shift register. The waveform information generator 277 may also store a predetermined time (equal to or greater than 0) after the second gate signal has been input and generate the noise-reduced digital signal from the timing at which the first gate signal is input to a predetermined timing as the waveform information in order to reduce the memory.

The second memory 278 stores the waveform information generated by the waveform information generator 277. The second memory 278 has a multi-layered structure and stores the waveform information for each waveform (one piece of waveform information). For example, the second memory 278 has 4000×5 multilayered structure and has a configuration in which 1 to 4000 signals are stored when one waveform has come and signals are stored in a next layer when a next waveform comes.

Hardware of the transmission terminal 20 will be described below. Electric power of the transmission terminal 20 is supplied from an external power supply, a primary battery, a secondary battery, a solar battery, an energy harvester, or the like. The transmission terminal 20 is realized by an analog circuit and a digital circuit. The digital circuit is realized, for example, by an FPGA or a microcomputer. The digital circuit may be realized by a dedicated LSI circuit. The transmission terminal 20 may have a nonvolatile memory such as a flash memory or a removable memory mounted therein.

### Configuration of collection apparatus 30

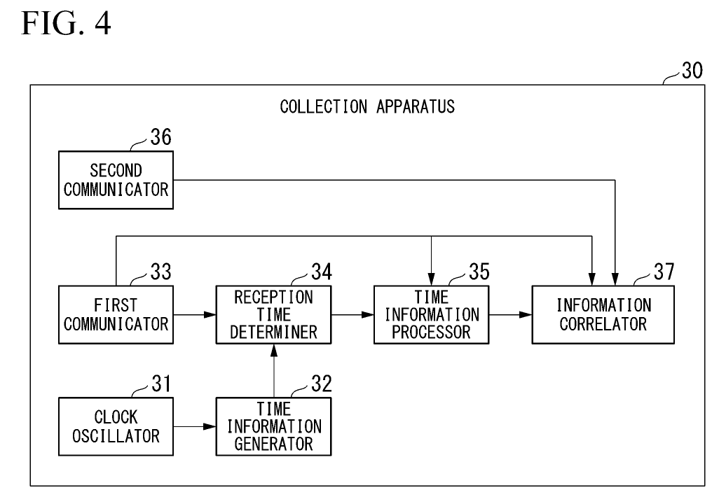

FIG. 4 is a block diagram schematically illustrating functions of the collection apparatus 30 according to the first embodiment. The collection apparatus 30 includes a clock oscillator 31, a time information generator 32, a first communicator 33, a reception time determiner 34, a time information processor 35, a second communicator 36, and an information correlator 37.

The clock oscillator 31 generates a clock signal. Specifically, the clock oscillator 31 determines a time width of 1 second in the collection apparatus 30. The clock oscillator 31 is constituted, for example, using a voltage-varying quartz oscillator such as a VCXO. The clock oscillator 31 outputs the clock signal to the time information generator 32.

The time information generator 32 determines a time in the collection apparatus 30 according to the clock signal output from the clock oscillator 31. The time information generator 32 is, for example, a counter including a register. That is, the time information generator 32 counts an edge of the clock signal and stores a cumulative count value from powering-on of the collection apparatus 30 as time information in the register.

The first communicator 33 is a communication interface that communicates with the transmission terminal 20 via the network 40-1. The first communicator 33 receives the first transmission data transmitted from the transmission terminal 20.

The reception time determiner 34 determines a reception time on the basis of a received signal. Specifically, the reception time determiner 34 determines a time at which the first transmission data transmitted from the transmission terminal 20 has been received by the first communicator 33 as a reception time. The reception time generally indicates a reception start time, a time at which a preamble has been detected, or a time at which a synchronous word has been found, but is not limited thereto.

The time information processor 35 estimates an event sensing time at the time of occurrence of an event by statistically processing the transmission times included in a plurality of pieces of first transmission data received and the reception times of the pieces of first transmission data.

The second communicator 36 is a communication interface that communicates with the transmission terminal 20 via the network 40-2. The second communicator 36 receives the second transmission data transmitted from the transmission terminal 20. The second communicator 36 may request the transmission terminal 20 to transmit the second transmission data in response to a request from the outside. In this case, the second communicator 36 transmits one of the event sensing time, the transmission time, and the specific identification information to the transmission terminal 20 such that the requested second transmission data can be identified by the transmission terminal 20. Accordingly, the transmission terminal 20 can transmit the second transmission data including waveform information identified by the event sensing time, the transmission time, or the specific identification information.

The information correlator 37 stores one or more pieces of first transmission data received via the first communicator 33 and one or more pieces of second transmission data received via the second communicator 36. Then, the information correlator 37 correlates the first transmission data received via the first communicator 33 with the second transmission data received via the second communicator 36. Specifically, the information correlator 37 correlates the first transmission data and the second transmission data on the basis of one of the event sensing time, the transmission time, and the specific identification information included in the first transmission data and one of the event sensing time, the transmission time, and the specific identification information included in the second transmission data.

For example, when correlation is performed using the specific identification information, the information correlator 37 identifies the second transmission data including specific identification information corresponding to the specific identification information using the specific identification information included in the first transmission data to be correlated. The information correlator 37 correlates the identified second transmission data with the first transmission data.

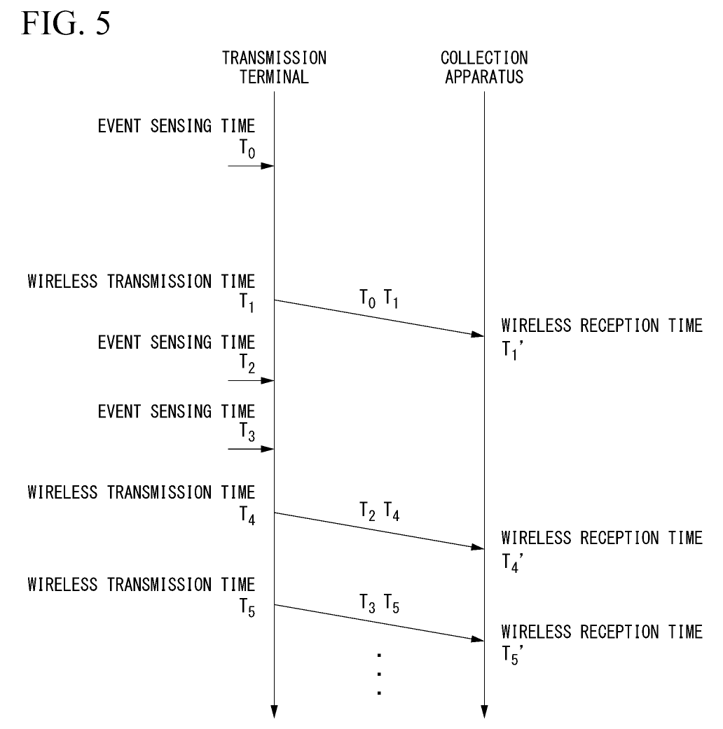

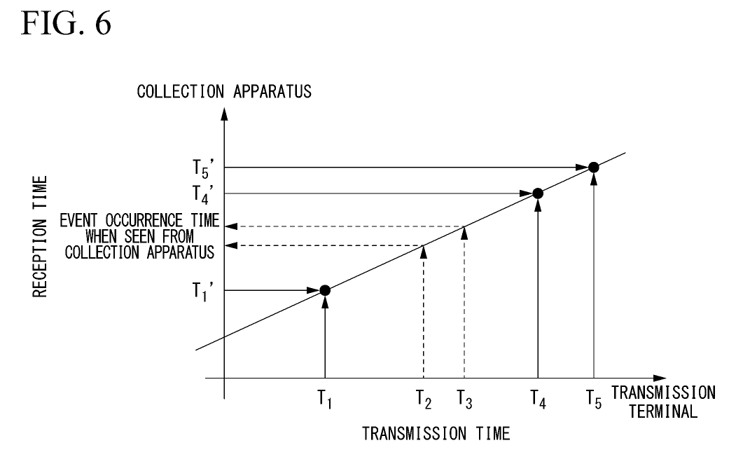

FIGS. 5 and 6 are diagrams illustrating time processing according to the first embodiment. As illustrated in FIG. 5, the transmission terminal 20 acquires the event sensing time using the event time determiner 273 when an event occurs and transmits the first transmission data including information of the event sensing time to the collection apparatus 30 using the first communicator 28. Specifically, when an event occurs, the transmission terminal 20first determines a time T₀ at which the event has occurred as the event sensing time. Then, the transmission terminal 20 generates first transmission data including the event sensing time T₀ and a transmission time T₁ and transmits the generated first transmission data to the collection apparatus 30 at the time T₁. The collection apparatus 30 receives the first transmission data transmitted from the transmission terminal 20. The collection apparatus 30 determines a time T₁’ at which the first transmission data has been received as a reception time. When the first transmission data including at least the transmission time is received from the transmission terminal 20, the collection apparatus 30 determines the reception time using the reception time determiner 34. When occurrence of an event is earlier than a transmission operation as illustrated in FIG. 5, transmission from the transmission terminal 20 is made to wait and the transmission is started at a transmittable timing.

FIG. 6 illustrates a relationship between the transmission time in the transmission terminal 20 and the reception time in the collection apparatus 30. The collection apparatus 30 calculates the graph illustrated in FIG. 6 on the basis of information of the reception time and information of the transmission time transmitted from the transmission terminal 20. For example, the collection apparatus 30 can calculate a relationship associated with times such as the transmission time T₁ and the reception time T₁’ and the transmission time T₄ and the reception time T₄’. In the present embodiment, the collection apparatus 30 acquires a relationship between counter values by statistically processing time stamps and counter values associated with a plurality of pieces of transmission data and estimates the event sensing time. The relationship between the counter values can be calculated by regression analysis and can be calculated, for example, using a method such as a least square method or principal component analysis (PCA). In this case, the event sensing time can be estimated from the relationship of y=ax+b. A parametric or nonparametric method may be used to calculate the relationship between the counter values. It is not necessary to wait for occurrence of all events and it is possible to estimate the event sensing time when two or more transmission times and two or more reception times are acquired between one transmission terminal 20 and the collection apparatus 30. As a specific estimation method, the method described in Patent Document 1 (Japanese Unexamined Patent Application, First Publication No. 2021-13141) is used.

The collection apparatus 30 may calculate a time difference (for example, a difference ΔT₃₂ between T₃ and T₂) using a plurality of transmission times. In this case, the collection apparatus 30 can convert the event sensing time to necessary information without directly estimating the event sensing time.

An error associated with a clock or an error based on priority processing in a microprocessor is further averaged in comparison with a case in which only reception time stamps (reception times) are used or a case in which an estimation method called ETA in the related art is used. Accordingly, it is possible to decrease an error of the event sensing time. Since the event sensing time is converted to the counter value in the reception-side collection apparatus 30, it is easier to perform comparison between a plurality of terminals. Accordingly, it can be very usefully applied to an application with a higher sampling rate such as position location using the sensor.

### Operations

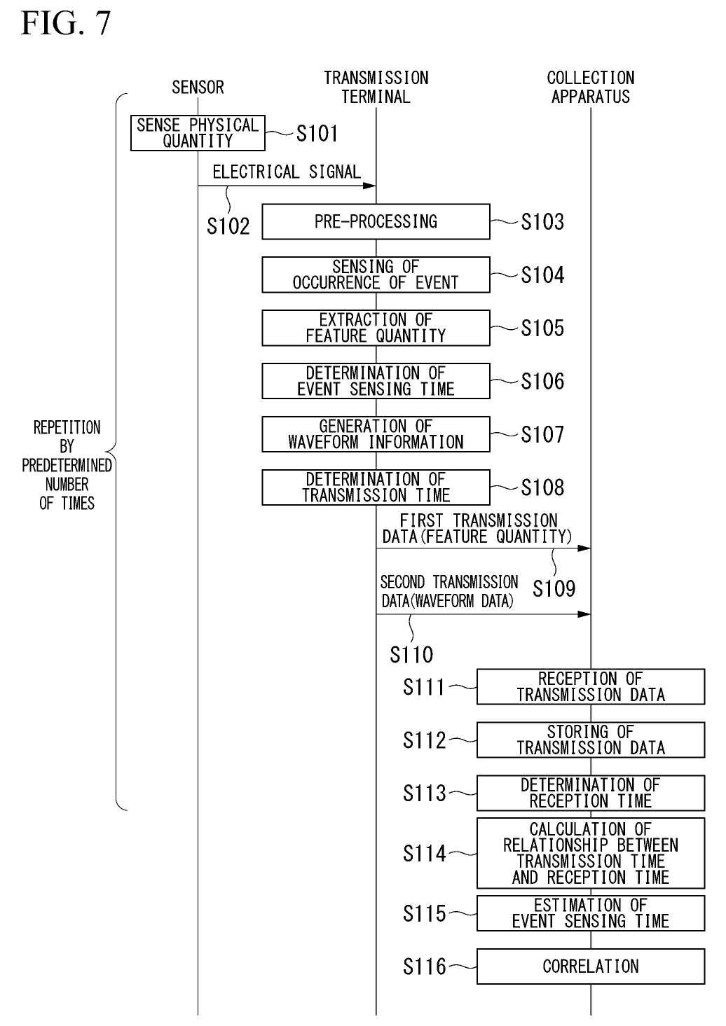

FIG. 7 is a sequence diagram illustrating a process flow that is performed by the sensor system 100 according to the first embodiment. The sensor 10 senses a physical quantity (Step S101). For example, the sensor 10 detects elastic waves. The sensor 10 converts the detected elastic waves to an electrical signal. The sensor 10 transmits the electrical signal to the transmission terminal 20 (Step S102). The receiver 21 of the transmission terminal 20 receives the electrical signal transmitted from the sensor 10. The transmission terminal 20 performs pre-processing on the received electrical signal (Step S103). Accordingly, a noise-reduced digital signal is input to the signal processor 27 of the transmission terminal 20.

The event signal generator 271 of the signal processor 27 senses occurrence of an event on the basis of the noise-reduced digital signal (Step S104). The event signal generator 271 outputs a first gate signal to the feature quantity extractor 272, the event time determiner 273, and the waveform information generator 277. The feature quantity extractor 272 extracts a feature quantity from the noise-reduced digital signal input at the timing at which the first gate signal output from the event signal generator 271 has been input (Step S105). The feature quantity extractor 272 outputs the extracted feature quantity to the sensing signal generator 274.

The event time determiner 273 determines a time at which the first gate signal has been inputted as the event sensing time (Step S106). The event time determiner 273 outputs time information indicating the determined event sensing time to the sensing signal generator 274. The waveform information generator 277 generates waveform information on the basis of the noise-reduced digital signal input at the timing at which the first gate signal has been input (Step S107). The waveform information generator 277 stores the generated waveform information in the second memory 278. At this time, the waveform information generator 277 adds one of the event sensing time, the transmission time, and the specific identification information as a header or a footer to the waveform information.

The sensing signal generator 274 receives the feature quantity output from the feature quantity extractor 272 and the time information including the event sensing time output from the event time determiner 273 as inputs. The sensing signal generator 274 generates sensing information in which the feature quantity is correlated with the time information indicating the event sensing time and outputs the generated sensing information to the first memory 276.

The communication time determiner 275 receives the time information generated by the time information generator 26 as an input. The communication time determiner 275 determines the transmission time on the basis of the input time information (Step S108). The communication time determiner 275 outputs information of the determined transmission time to the first communicator 28. The first communicator 28 generates the first transmission data including the sensing information stored in the first memory 276 and the transmission time output from the communication time determiner 275. The first communicator 28 transmits the generated first transmission data to the collection apparatus 30 (Step S109).

The second communicator 29 generates second transmission data including the waveform information stored in the second memory 278. The second communicator 29 transmits the generated second transmission data to the collection apparatus 30 (Step S110). In FIG. 7, a configuration in which the first transmission data and the second transmission data are sequentially transmitted is illustrated for the purpose of convenience of explanation, but the second transmission data is not necessarily transmitted. For example, the second transmission data may be transmitted at a timing requested from the collection apparatus 30 or may be transmitted at a timing at which an amount of data stored in the second memory 278 is greater than a certain threshold value. In this way, the first transmission data and the second transmission data are not necessarily transmitted at close timings.

The first communicator 33 of the collection apparatus 30 receives the first transmission data transmitted from the transmission terminal 20. The first communicator 33 outputs the received first transmission data to the reception time determiner 34, the time information processor 35, and the information correlator 37. The second communicator 36 of the collection apparatus 30 receives the second transmission data transmitted from the transmission terminal 20 (Step S111). The second communicator 36 outputs the received second transmission data to the information correlator 37. The information correlator 37 stores the first transmission data and the second transmission data (Step S112).

The reception time determiner 34 determines a reception time on the basis of the time information generated by the time information generator 32 and the first transmission data output from the first communicator 33 (Step S113). Specifically, the reception time determiner 34 determines a time indicated by the time information at the time point at which the first transmission data has been acquired as the reception time. The reception time determiner 34 outputs information of the determined reception time to the time information processor 35. The time information processor 35 correlates the first transmission data output from the first communicator 33 with the information of the reception time output from the reception time determiner 34 and stores the resultant information in a storage which is not illustrated.

The processes of Steps S101 to S113 are repeatedly performed by a predetermined number of times. Accordingly, a plurality of pieces of first transmission data and a plurality of pieces of reception times are stored in the time information processor 35. When a predetermined number of pieces of first transmission data and information of the reception times are stored, the time information processor 35 calculates a relationship between the transmission times and the reception times on the basis of information of the transmission time included in the plurality of pieces of first transmission data stored in the storage and information of the plurality of reception times (Step S114). Specifically, the time information processor 35 calculates the graph illustrated in FIG. 6 using the information of a plurality of transmission times and the information of a plurality of reception times. Thereafter, the time information processor 35 estimates an event sensing time on the basis of the relationship between the transmission times and the reception times acquired from the calculated graph (Step S115). The time information processor 35 may output the event sensing time to the information correlator 37.

The information correlator 37 correlates one or more pieces of stored first transmission data with one or more pieces of second transmission data (Step S116). The information correlator 37 may also correlate information of the event sensing time output from the time information processor 35. The correlation process in the information correlator 37 may be performed at a predetermined timing or may be performed at an instructed timing.

With the sensor system 100 having the aforementioned configuration, the transmission terminal 20 includes the first communicator 28 configured to transmit first transmission data including time information to be used for time estimation to the collection apparatus 30 in a wireless manner and the second communicator 29 configured to transmit second transmission data including information (for example, waveform information) acquired on the basis of a physical quantity (elastic waves) sensed by one or more sensors 10 to the collection apparatus 30 at a frequency different from a frequency used by the first communicator 28 in a wireless manner. The collection apparatus 30 includes the reception time determiner 34 configured to determine a plurality of reception times of a plurality of pieces of first transmission data transmitted from the first communicator 28 and the time information processor 35 configured to perform time estimation on the basis of the plurality of pieces of first transmission data and the plurality of reception times.

Accordingly, time information used for time estimation and other information are transmitted from the different communicators. The first communicator 28 and the second communicator 29 are communicators using different frequencies and thus do not affect communication of the communicators. Accordingly, the collection apparatus 30 can receive time information used for time information. As a result, it is possible to accurately perform time estimation. Accordingly, it is possible to curb a decrease in time estimation accuracy.

The collection apparatus 30 further includes the information correlator 37 configured to correlate the second transmission data transmitted from the second communicator 29 and the first transmission data transmitted from the first communicator 28. Accordingly, it is possible to correlate and store data transmitted from different communicators. As a result, it is possible to improve convenience.

Particularly, the second transmission data includes identification information (for example, one of an event sensing time, a transmission time of the first transmission data, and specific identification information for the first transmission data) for performing correlation with the first transmission data. The information correlator 37 correlates the second transmission data and the first transmission data on the basis of the identification information included in the second transmission data. Accordingly, it is possible to easily perform correlation of information in the collection apparatus 30.

The first communicator 28 transmits the first transmission data further including a feature quantity acquired on the basis of the physical quantity to the collection apparatus 30 in a wireless manner. The second communicator 29 transmits the second transmission data including waveform information of the physical quantity to the collection apparatus 30 in a wireless manner. In this way, the waveform information with a large amount of data transmitted is transmitted from a communicator other than the communicator transmitting time information used for time estimation to the collection apparatus 30. Accordingly, it is possible to reduce a situation in which time information used for time estimation cannot be transmitted by transmitting the waveform information. As a result, it is possible to curb a decrease in estimation accuracy of time estimation due to transmission of the waveform information.

### Second embodiment

In a second embodiment, a configuration in which the sensor system 100 according to the first embodiment is applied to position location of a source of elastic waves will be described.

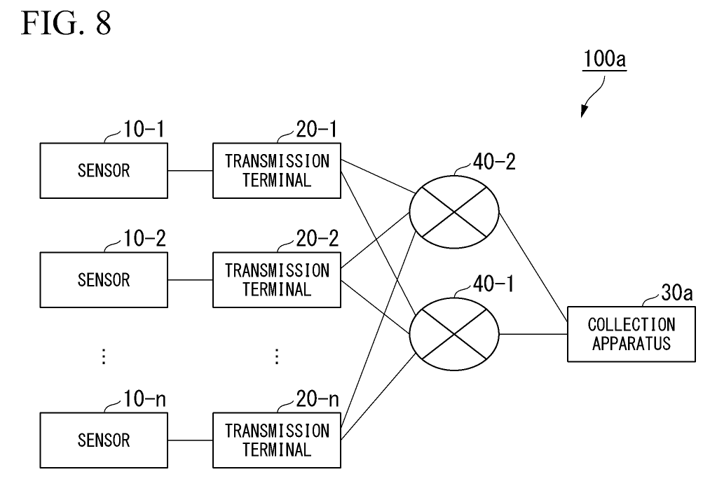

FIG. 8 is a diagram illustrating a system configuration of a sensor system 100a according to the second embodiment. The sensor system 100a includes a sensor 10, a transmission terminal 20, and a collection apparatus 30a. The sensor 10 and the transmission terminal 20 are connected in a wired manner. The transmission terminal 20 and the collection apparatus 30a are connected via networks 40-1 and 40-2 in a wireless manner. The sensor system 100a includes n sensors 10 and n transmission terminals 20 (where n is an integer equal to or greater than 3).

In the following description, the sensors 10-1 to 10-n are referred to as a sensor 10 when they are not distinguished. In the following description, the transmission terminals 20-1 to 20-n are referred to as transmission terminals 20 when they are not distinguished. In FIG. 8, one transmission terminal 20 and one sensor 10 are connected, but a plurality of sensors 10 may be connected to one transmission terminal 20. When functional units in a device are distinguished, a branch number is added to the functional units to distinguish the functional units. For example, when functional units of the transmission terminal 20-1 are described, a branch number of -1 is added to the functional units to distinguish the functional units from the functional units of other devices.

The sensor system 100a has a configuration different from that of the sensor system 100 in that a plurality of sensors 10 and a plurality of transmission terminals 20 are provided and the collection apparatus 30a is provided instead of the collection apparatus 30. The sensor system 100a is the same as the sensor system 100 in the other configurations. Differences from the sensor system 100 will be mainly described below.

The collection apparatus 30a performs the same process as the collection apparatus 30 according to the first embodiment. The collection apparatus 30a locates a position of a source of elastic waves on the basis of a feature quantity included in transmission data transmitted from the transmission terminals 20.

Configuration of collection apparatus 30a

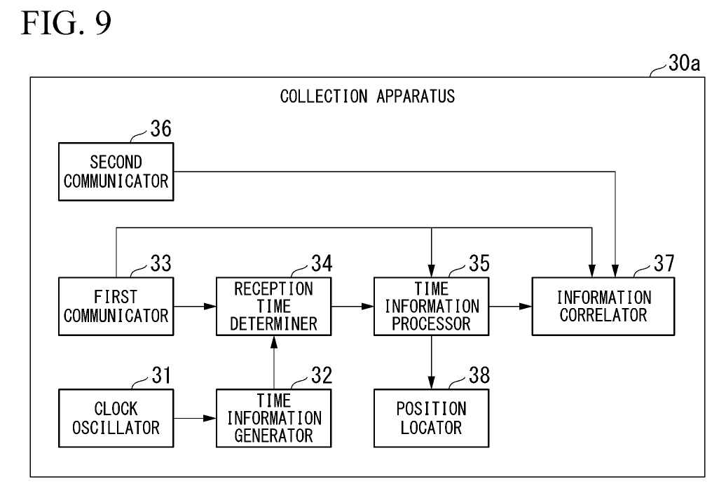

FIG. 9 is a block diagram schematically illustrating functions of the collection apparatus 30a according to the second embodiment. The collection apparatus 30a includes a clock oscillator 31, a time information generator 32, a first communicator 33, a reception time determiner 34, a time information processor 35, a second communicator 36, an information correlator 37, and a position locator 38.

The position locator 38 receives an estimation result of an event sensing time output from the time information processor 35 and sensing information as inputs. The position locator 38 locates a position of a source of elastic waves on the basis of the input estimation result of the event sensing time and the sensing information.

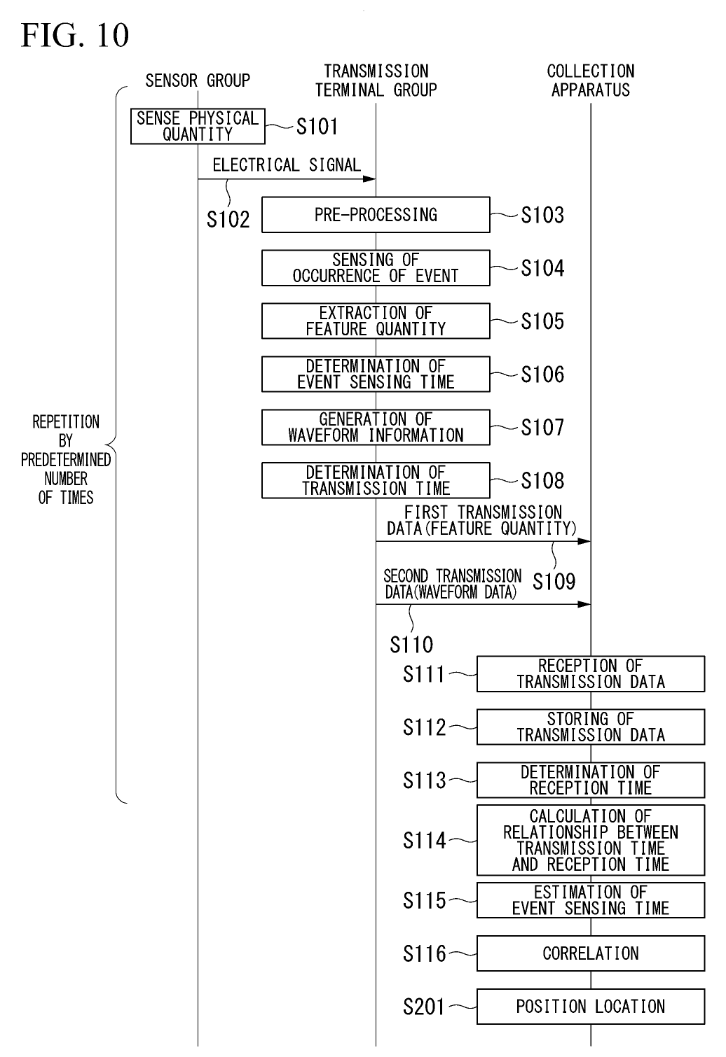

FIG. 10 is a sequence diagram illustrating a process flow that is performed by the sensor system 100a according to the second embodiment. In FIG. 10, a plurality of sensors 10 are collectively referred to as a sensor group, and a plurality of transmission terminals 20 are collectively referred to as a transmission terminal group. In FIG. 10, it is assumed that the sensor 10-1 is connected to the transmission terminal 20-1, the sensor 10-2 is connected to the transmission terminal 20-2, and the sensor 10-3 is connected to the transmission terminal 20-3.

The sensor group senses a physical quantity (Step S101). For example, the sensors 10-1 to 10-3 detect elastic waves. The sensors 10-1 to 10-3 convert the detected elastic waves to an electrical signal. The sensors 10-1 to 10-3 transmit the electrical signal to the transmission terminals 20-1 to 20-3 connected thereto (Step S102). The receivers 21-1 to 21-3 of the transmission terminals 20-1 to 20-3 receive the electrical signal transmitted from the sensors 10-1 to 10-3. The transmission terminals 20-1 to 20-3 perform pre-processing on the received electrical signal (Step S103). Accordingly, a noise-reduced digital signal is input to the signal processors 27-1 to 27-3 of the transmission terminals 20-1 to 20-3.

The event signal generators 271-1 to 271-3 of the signal processors 27-1 to 27-3 sense occurrence of an event on the basis of the noise-reduced digital signal (Step S104). The event signal generators 271-1 to 271-3 output a first gate signal to the feature quantity extractors 272-1 to 272-3, the event time determiners 273-1 to 273-3, and the waveform information generators 277-1 to 277-3. The feature quantity extractors 272-1 to 272-3 extract a feature quantity from the noise-reduced digital signal input at the timing at which the first gate signal output from the event signal generators 271-1 to 271-3 has been input (Step S105). The feature quantity extractors 272-1 to 272-3 output the extracted feature quantity to the sensing signal generators 274-1 to 274-3.

The event time determiners 273-1 to 273-3 determine a time at which the first gate signal has been inputted as the event sensing time (Step S106). The event time determiners 273-1 to 273-3 output time information indicating the determined event sensing time to the sensing signal generators 274-1 to 274-3. The waveform information generators 277-1 to 277-3 generate waveform information on the basis of the noise-reduced digital signal input at the timing at which the first gate signal has been input (Step S107). The waveform information generators 277-1 to 277-3 store the generated waveform information in the second memories 278-1 to 278-3. At this time, the waveform information generators 277-1 to 277-3 add one of the event sensing time, the transmission time, and the specific identification information as a header or a footer to the waveform information.

The sensing signal generators 274-1 to 274-3 receive the feature quantity output from the feature quantity extractors 272-1 to 272-3 and the time information including the event sensing time output from the event time determiners 273-1 to 273-3 as inputs. The sensing signal generators 274-1 to 274-3 generate sensing information in which the feature quantity is correlated with the time information indicating the event sensing time and outputs the generated sensing information to the first memories 276-1 to 276-3.

The communication time determiners 275-1 to 275-3 receive the time information generated by the time information generators 26-1 to 26-3 as an input. The communication time determiners 275-1 to 275-3 determine the transmission time on the basis of the input time information (Step S108). The communication time determiners 275-1 to 275-3 output information of the determined transmission time to the first communicators 28-1 to 28-3. The first communicators 28-1 to 28-3 generate the first transmission data including the sensing information stored in the first memories 276-1 to 276-3 and the transmission time output from the communication time determiners 275-1 to 275-3. The first communicators 28-1 to 28-3 transmit the generated first transmission data to the collection apparatus 30a (Step S109).

The second communicators 29-1 to 29-3 generate second transmission data including the waveform information stored in the second memories 278-1 to 278-3. The second communicators 29-1 to 29-3 transmit the generated second transmission data to the collection apparatus 30a (Step S110). In FIG. 10, a configuration in which the first transmission data and the second transmission data are sequentially transmitted is illustrated for the purpose of convenience of explanation, but the second transmission data is not necessarily transmitted. For example, the second transmission data may be transmitted at a timing requested from the collection apparatus 30a or may be transmitted at a timing at which an amount of data stored in the second memories 278-1 to 278-3 is greater than a certain threshold value. In this way, the first transmission data and the second transmission data are not necessarily transmitted at close timings.

The first communicator 33 of the collection apparatus 30a receives the first transmission data transmitted from the transmission terminals 20-1 to 20-3. The first communicator 33 outputs the received first transmission data to the reception time determiner 34, the time information processor 35, and the information correlator 37. The second communicator 36 of the collection apparatus 30a receives the second transmission data transmitted from the transmission terminals 20-1 to 20-3 (Step S111). The second communicator 36 outputs the received second transmission data to the information correlator 37. The information correlator 37 stores the first transmission data and the second transmission data (Step S112).

The reception time determiner 34 determines a reception time on the basis of the time information generated by the time information generator 32 and the first transmission data output from the first communicator 33 (Step S113). Specifically, the reception time determiner 34 determines a time indicated by the time information at the time point at which the first transmission data has been acquired as the reception time. The reception time determiner 34 outputs information of the determined reception time to the time information processor 35. The time information processor 35 correlates the first transmission data output from the first communicator 33 with the information of the reception time output from the reception time determiner 34 and stores the resultant information in a storage which is not illustrated.

The processes of Steps S101 to S113 are repeatedly performed by a predetermined number of times. Accordingly, a plurality of pieces of first transmission data and a plurality of pieces of reception times are stored in the time information processor 35. When a predetermined number of pieces of first transmission data and information of the reception times are stored, the time information processor 35 calculates a relationship between the transmission times and the reception times on the basis of information of the transmission time included in the plurality of pieces of first transmission data stored in the storage and information of the plurality of reception times (Step S114). Specifically, the time information processor 35 calculates the graph illustrated in FIG. 6 using the information of a plurality of transmission times and the information of a plurality of reception times. Thereafter, the time information processor 35 estimates an event sensing time on the basis of the relationship between the transmission times and the reception times acquired from the calculated graph (Step S115). The time information processor 35 outputs the event sensing time and the sensing information to the position locator 38. The time information processor 35 may output the event sensing time to the information correlator 37.

The information correlator 37 correlates one or more pieces of stored first transmission data with one or more pieces of second transmission data (Step S116). The information correlator 37 may also correlate information of the event sensing time output from the time information processor 35. The correlation process in the information correlator 37 may be performed at a predetermined timing or may be performed at an instructed timing.

The position locator 38 locates a position of a source of elastic waves on the basis of the event sensing time and the sensing information (Step S201). Specifically, first, the position locator 38 calculates similarity between feature quantity information pieces included in the sensing information and groups the plurality of pieces of sensing information on the basis of whether the similarity between the feature quantity information pieces is equal to or greater than a predetermined threshold value. Then, the position locator 38 recognizes the sensing information included in the same group as sensing information of the same source.

The similarity is determined on the basis of a distance between a feature quantity information piece and a feature quantity information piece. That is, the similarity becomes larger as the distance between the different feature quantity information pieces becomes smaller. The position locator 38 calculates the distance between the feature quantity information pieces using a predetermined distance function. The distance function is, for example, a function of calculating a standard Euclidean distance, a Minkowski distance, a Mahalanobis distance, or the like. Particularly, the Mahalanobis distance enables a distance to be calculated in consideration of a correlation between the feature quantity information pieces and can improve grouping accuracy. Then, the position locator 38 calculates time difference information between the reception times of elastic waves in the plurality of sensors 10 by comparing the estimated event sensing times correlated with feature quantity information pieces (feature quantity information pieces of the sensing information included in the same group) in which the similarity is equal to or greater than a predetermined threshold value. The position locator 38 identifies position information of the source of elastic waves on the basis of position information between the sensors 10, time difference information, and a propagation speed of elastic waves.

With the sensor system 100a having the aforementioned configuration, it is possible to achieve the same advantages as in the first embodiment.

In the sensor system 100a, the event sensing time for each sensor 10 is estimated on the basis of information acquired from the sensors 10. Specifically, the collection apparatus 30a estimates the event sensing time through correction for decreasing a time error. Accordingly, the collection apparatus 30a locates the position of an event source on the basis of the corrected event sensing time and thus can accurately locate the position.

### Modified examples

Accuracy of arrival time is important in position location. Accordingly, a maximum acquisition time may be determined in the waveform information generated by the signal processor 27 in order to secure a communication capacity.

### Modified Example 1 shared by first embodiment and second embodiment

In the aforementioned embodiments, the waveform information generator 277 generates waveform information on the basis of the timing at which the first gate signal has been input. The first gate signal is a signal that is output at a rising timing of an elastic wave. In order to sense the rising timing of an elastic wave in this way, the threshold value for outputting the first gate signal is basically set to be low. When the waveform information generator 277 generates the waveform information on the basis of the timing at which the first gate signal has been input, there is a likelihood that an unnecessary noise-reduced digital signal (for example, a noise-reduced digital signal with small amplitude) which is not used for processing will be transmitted as the waveform data. Therefore, the waveform information generator 277 may be configured to generate waveform information of the noise-reduced digital signal used for processing as the waveform data. With this configuration, the waveform information generator 277 may generate the waveform information on the basis of the timing at which the noise-reduced digital signal of which the amplitude is equal to or greater than a second threshold value has been sensed. The second threshold value is a value greater than the first threshold value.

### Modified Example 2 shared by first embodiment and second embodiment

The waveform information generator 277 may determine whether to generate waveform information on the basis of a feature quantity. For example, the waveform information generator 277 may perform the determination on the basis of a rising time of a waveform or a hit interval as the feature quantity. The same waveform may be observed continuously due to reflection or the like. In this case, it is meaningless to generate waveform information of all waveforms. Therefore, when the same waveform is observed continuously on the basis of hit intervals, the waveform information generator 277 generates waveform information on the basis of a first observed waveform. When the rising time of a waveform is large, the amplitude thereof is also assumed to be large. Therefore, the waveform information generator 277 may generate waveform information on the basis of the timing at which a noise-reduced digital signal in which the rising time of a waveform is equal to or greater than a certain threshold value has been sensed.

### Modified Example 3 shared by first embodiment and second embodiment

In the aforementioned embodiments, a configuration in which the second communicator 29 is normally operating is described. The first transmission data transmitted from the first communicator 28 is necessary for time estimation in the collection apparatuses 30 and 30a, but the second transmission data transmitted from the second communicator 29 is not necessary. Accordingly, the second communicator 29 may be in a dormant state. The dormant state is a state for achieving power saving and may be, for example, a sleep state or a state in which the operation is stopped. With this configuration, the second communicator 29 may be started when predetermined conditions are satisfied. For example, the second communicator 29 is switched to a start state when predetermined conditions such as a condition in which an arbitrary time has come or a condition in which a signal transmitted from the collection apparatus 30 or 30a has been received are satisfied. Then, the second communicator 29 transmits the second transmission data including waveform information stored in the second memory 278 to the collection apparatus 30 or 30a. Accordingly, it is possible to achieve power saving.

### Modified Example 4 shared by first embodiment and second embodiment

In the aforementioned embodiments, a configuration in which first transmission data including sensing information (which includes a feature quantity) and a transmission time is transmitted by the first communicator 28 and second transmission data including waveform information is transmitted by the second communicator 29 is described. On the other hand, a configuration in which first transmission data including some feature quantities, an event sensing time, and a transmission time is transmitted by the first communicator 28 and second transmission data including all the feature quantities is transmitted by the second communicator 29 may be employed. With this configuration, the signal processor 27 may not include the waveform information generator 277. The feature quantity extractor 272 extracts feature quantities of a noise-reduced digital signal using the noise-reduced digital signal input while the first gate signal is being input. The feature quantity extractor 272 stores the extracted feature quantities in the second memory 278. The feature quantity extractor 272 extracts the feature quantities of the noise-reduced digital signal using the noise-reduced digital signal in which the amplitude is greater than the second threshold value. The feature quantity extractor 272 outputs the extracted feature quantities to the sensing signal generator 274. Accordingly, some feature quantities extracted from the noise-reduced digital signal input to the signal processor 27 is transmitted by the first communicator 28. Then, all the feature quantities extracted from the noise-reduced digital signal input to the signal processor 27 are transmitted by the second communicator 29.

### Modified Example 5 shared by first embodiment and second embodiment

In the aforementioned embodiments, a configuration in which the first transmission data including sensing information (which includes a feature quantity) and a transmission time is transmitted by the first communicator 28 and the second transmission data including waveform information is transmitted by the second communicator 29 is described. When the feature quantities are transmitted by the first communicator 28 in this way, the number of feature quantities to be transmitted depends on the number of pieces of data of elastic waves. Accordingly, a problem with difficulty of adjustment of the second threshold value or the like is caused when the number of elastic waves is large or according to the intensity of the elastic waves or the like. For example, when time division multiple access (TDMA) is used for wireless collision avoidance, a wireless signal is transmitted for Y seconds every X seconds.

Therefore, a configuration in which first transmission data including time information based on a dummy event is transmitted by the first communicator 28 and second transmission data including all the feature quantities is transmitted by the second communicator 29 may be employed. With this configuration, the signal processor 27 may not include the waveform information generator 277. Here, the dummy event is an event in which occurrence of an event is not sensed by the event signal generator 271 and which does not occur actually. That is, the dummy event is a virtual event. More specifically, the transmission terminal 20 transmits the first transmission data including a transmission time to the collection apparatus 30 or 30a after a dummy event has occurred. The dummy event may be caused by the communication time determiner 275, may be caused by the first communicator 28, or may be caused by a dummy event generator newly provided in the transmission terminal 20. The feature quantity extractor 272 extracts feature quantities of the noise-reduced digital signal using the noise-reduced digital signal input while the first gate signal is being input. The feature quantity extractor 272 stores the extracted feature quantities in the second memory 278. Accordingly, the second transmission data including the feature quantities is transmitted to the collection apparatus 30 or 30a by the second communicator 29.

In the collection apparatus 30 or 30a, time estimation becomes possible by correcting an arrival time at which the second transmission data is received using the time estimation result based on the first transmission data. The second communicator 29 may transmit data when the feature quantities are stored in the second memory 278 or may transmit data at a timing at which a predetermined number of pieces of data is stored in the second memory 278 or a timing at which a predetermined time has elapsed.

### Modified Example 6 shared by first embodiment and second embodiment

In order to improve time accuracy, the first communicator 28 may transmit the first transmission data including a transmission time at equal intervals.

### Modified Example 7 shared by first embodiment and second embodiment

When the first communicator 28 and the second communicator 29 use different frequencies in the same wireless standard, data to be transmitted may be switched according to communication intensities. For example, the transmission terminal 20 transmits transmission data including a feature quantity and time information indicating the transmission time using a communicator with a high communication intensity. With this configuration, the transmission terminal 20 measures communication intensities of the first communicator 28 and the second communicator 29 and performs control such that transmission data including a feature quantity and time information indicating a transmission time is transmitted to the collection apparatus 30 or 30a using a communicator with higher communication intensity. Accordingly, it is possible to more reliably transmit information of a feature quantity with higher priority or information of a transmission time used for time estimation to the collection apparatus 30 or 30a.

According to at least one embodiment described above, one or more transmission terminals 20 include the first communicator 28 configured to transmit first transmission data including time information to be used for time estimation to the collection apparatus 30 or 30a in a wireless manner and the second communicator 29 configured to transmit second transmission data including information acquired on the basis of a physical quantity to the collection apparatus 30 or 30a at a frequency different from a frequency used by the first communicator 28 in a wireless manner. The collection apparatus 30 or 30a includes the reception time determiner 34 configured to determine a plurality of reception times of a plurality of pieces of first transmission data transmitted from the first communicator 28 and the time information processor 35 configured to perform time estimation on the basis of the plurality of pieces of first transmission data and the plurality of reception times, and thus it is possible to curb a decrease in time estimation accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sensor system comprising one or more sensors configured to sense a physical quantity, one or more transmission terminals connected to the one or more sensors, and a collection apparatus configured to collect information transmitted from the one or more transmission terminals,
wherein the one or more transmission terminals include
a first communicator configured to transmit first transmission data including time information to be used for time estimation to the collection apparatus in a wireless manner, and
a second communicator configured to transmit second transmission data including information acquired on a basis of the physical quantity sensed by the one or more sensors to the collection apparatus at a frequency different from a frequency used by the first communicator in a wireless manner, and
wherein the collection apparatus includes
a reception time determiner configured to determine a plurality of reception times of a plurality of pieces of first transmission data transmitted from the first communicator, and
a time information processor configured to perform time estimation on a basis of the plurality of pieces of first transmission data and the plurality of reception times.

2. The sensor system according to claim 1, wherein the collection apparatus further includes an information correlator configured to correlate the second transmission data transmitted from the second communicator and the first transmission data transmitted from the first communicator.

3. The sensor system according to claim 2, wherein the second transmission data includes identification information for performing correlation with the first transmission data, and
wherein the information correlator correlates the second transmission data and the first transmission data on the basis of the identification information.

4. The sensor system according to claim 3, wherein the identification information is one of an event sensing time, a transmission time of the first transmission data, and specific identification information for the first transmission data.

5. The sensor system according to claim 1, further comprising an information generator configured to determine data to be transmitted from the second communicator on the basis of a signal intensity of the physical quantity or a feature quantity of the physical quantity.

6. The sensor system according to claim 1, wherein the first communicator transmits the first transmission data further including a feature quantity acquired on the basis of the physical quantity to the collection apparatus in a wireless manner, and
wherein the second communicator transmits the second transmission data including waveform information of the physical quantity as information acquired on the basis of the physical quantity to the collection apparatus in a wireless manner.

7. The sensor system according to claim 1, wherein the second communicator transmits the second transmission data including a feature quantity of the physical quantity as information acquired on the basis of the physical quantity to the collection apparatus in a wireless manner, and
wherein the first communicator transmits the first transmission data further including a feature quantity acquired on the basis of the physical quantity greater than a certain threshold value to the collection apparatus.

8. The sensor system according to claim 1, wherein the first communicator transmits the first transmission data to the collection apparatus in a wireless manner on the basis of an event which occurs virtually, and
wherein the second communicator transmits the second transmission data including a feature quantity of the physical quantity as information acquired on the basis of the physical quantity to the collection apparatus in a wireless manner.

9. The sensor system according to claim 1, wherein a communication speed of the second communicator is equal to or higher than that of the first communicator.

10. The sensor system according to claim 1, wherein the second communicator starts when predetermined conditions are satisfied in a dormant state.

11. The sensor system according to claim 1, wherein the collection apparatus further includes a position locator configured to locate a source of an event in which the physical quantity is generated,
wherein the one or more sensors and the one or more transmission terminals are a plurality of sensors and a plurality of transmission terminals,
wherein the time information processor estimates a sensing time of the occurring event for each transmission terminal, and
wherein the position locator calculates time difference information of the event using the estimated sensing time of the occurring event for each transmission terminal and locates the source of the occurring event on the basis of the calculated time difference information, position information of each transmission terminal, and a propagation speed of the physical quantity sensed by each of the plurality of sensors.

12. A transmission terminal in a sensor system including one or more sensors configured to sense a physical quantity, one or more transmission terminals connected to the one or more sensors, and a collection apparatus configured to collect information transmitted from the one or more transmission terminals, the transmission terminal comprising:
a first communicator configured to transmit first transmission data including time information to be used for time estimation to the collection apparatus in a wireless manner; and
a second communicator configured to transmit second transmission data including information acquired on the basis of the physical quantity sensed by the one or more sensors to the collection apparatus at a frequency different from a frequency used by the first communicator in a wireless manner.

13. A transmission method that is performed by a transmission terminal in a sensor system including one or more sensors configured to sense a physical quantity, one or more transmission terminals connected to the one or more sensors, and a collection apparatus configured to collect information transmitted from the one or more transmission terminals, the transmission method comprising:
causing a first communicator to transmit first transmission data including time information to be used for time estimation to the collection apparatus in a wireless manner; and
causing a second communicator to transmit second transmission data including information acquired on the basis of the physical quantity sensed by the one or more sensors to the collection apparatus at a frequency different from a frequency used by the first communicator in a wireless manner.
